(19) United States
(12) Patent Application Publication
(10) Pub. No.: US 2020/0406350 A1
(43) Pub. Date: Dec. 31, 2020

(54) SINTERED ALLOY ARTICLES VIA ADDITIVE MANUFACTURING

(71) Applicant: Kennametal Inc., Latrobe, PA (US)

(72) Inventors: Martin G. PEREZ, Latrobe, PA (US); Michael J. Meyer, Ligonier, PA (US); Jose Veintimilla, Greensburg, PA (US); Jeffrey S. Lane, Greensburg, PA (US)

(21) Appl. No.: 16/451,434

(22) Filed: Jun. 25, 2019

(51) Int. Cl. B22F 1/00; B22F 3/105

(52) U.S. Cl. CPC B22F 1/0059; B22F 3/1055; B33Y 80/00; B22F 2301/05; B22F 2301/15

(57) ABSTRACT

Powder alloy compositions and associated additive manufacturing techniques are described herein for production of sintered articles with unique microstructure and/or enhanced wear and corrosion resistance. In some embodiments, an article comprises sintered powder cobalt-based alloy having metal carbide precipitates dispersed in a cobalt solid solution matrix phase, wherein the metal carbide precipitates are present in an amount of at least 50 weight percent of the sintered powder cobalt-based alloy.

### FIELD

The present invention relates to sintered alloy articles and, in particular, to sintered alloy articles fabricated via one or more additive manufacturing techniques.

### BACKGROUND

Additive manufacturing generally encompasses processes in which digital 3-dimensional (3D) design data is employed to fabricate an article or component in layers by material deposition and processing. Various techniques have been developed falling under the umbrella of additive manufacturing. Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process and precluding the requirement of mold lubricants and coolant. Most importantly, additive manufacturing enables significant freedom in article design. Articles having highly complex shapes can be produced without significant expense allowing the development and evaluation of a series of article designs prior to final design selection.

However, it is often difficult to manufacture alloy parts using additive manufacturing techniques, such as selective laser sintered (SLS) or selective laser melting (SLM). These processes are time consuming, and the resultant articles can exhibit substantial cracking due to internal stresses that form during the build.

### SUMMARY

In view of these deficiencies, powder alloy compositions and associated additive manufacturing techniques are described herein for production of sintered articles with unique microstructure and/or enhanced wear and corrosion resistance. In some embodiments, an article comprises sintered powder cobalt-based alloy having metal carbide precipitates dispersed in a cobalt solid solution matrix phase, wherein the metal carbide precipitates are present in an amount of at least 50 weight percent of the sintered powder cobalt-based alloy. In some embodiments, the metal carbide precipitates are present in an amount of at least 60 weight percent. Articles described herein can also exhibit complex shapes and contain one or more internal channels for passing fluid through the article.

In another aspect, methods of forming sintered articles are provided. Briefly, a method comprises providing powder cobalt-based alloy and forming the powder cobalt-based alloy into a green article by one or more additive manufacturing techniques. The green article is sintered to provide the sintered article comprising sintered powder cobalt-based alloy having metal carbide precipitates dispersed in a cobalt solid solution matrix phase, wherein the metal carbide precipitates are present in an amount of at least 50 weight percent of the sintered powder cobalt-based alloy. In some embodiments, the green article can be a single piece. Alternatively, the green article can comprise at least two individual segments defining an interface between the two individual segments.

These and other embodiments are further described in the following detailed description.

### BRIEF DESCRIPTION OF THE DRAWINGS

FIG. 1 is a cross-sectional optical microscopy image of a sintered cobalt-based alloy described herein, according to some embodiments.

FIG. 2 is a cross-sectional optical microscopy image of a comparative cobalt-based alloy article produced by sintering a printed green article.

FIG. 3 is a cross-section scanning electron microscopy (SEM) image of a sintered cobalt-based alloy described herein according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Sintered Articles

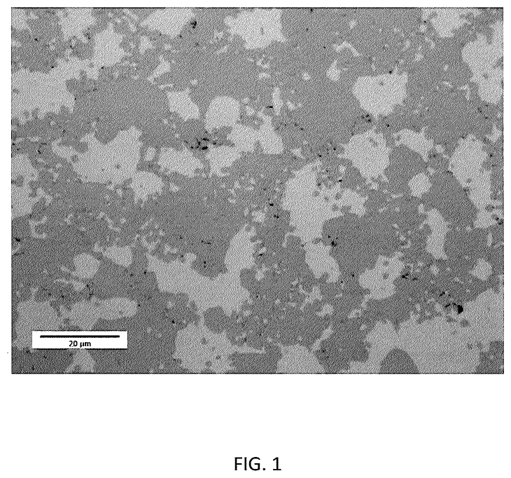

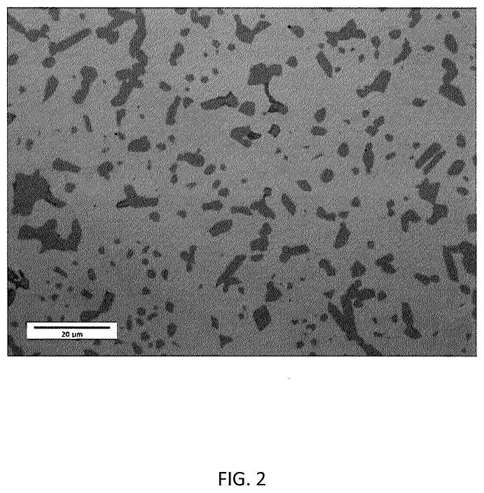

In one aspect, sintered alloy articles are described herein comprising desirable microstructural properties in addition to high hardness, corrosion and/or wear resistance. In some embodiments, an article comprises sintered powder cobalt-based alloy having metal carbide precipitates dispersed in a cobalt solid solution matrix phase, wherein the metal carbide precipitates are present in an amount of at least 50 weight percent of the sintered powder cobalt-based alloy. In some embodiments, the metal carbide precipitates are present in an amount of at least 60 weight percent. Metal carbide precipitates, for example, can be present in an amount of 55 to 75 weight percent. In some embodiments, the metal carbide precipitates are interconnected throughout the cobalt solid solution matrix phase. FIG. 1 is a cross-sectional optical microscopy image of a sintered cobalt-based alloy described herein, according to some embodiments. As illustrated in the image, metal carbide precipitates (dark) are dispersed throughout the cobalt solid solution matrix phase (light). The high occurrence of the metal carbide precipitates can form an interconnected structure in the cobalt solid solution matrix phase. The size and distribution of metal carbide precipitates in sintered articles described herein are in sharp contrast to other sintered cobalt alloy articles produced by additive manufacturing techniques. FIG. 2 is a cross-sectional optical microscopy image of a comparative cobalt-based alloy article produced by sintering a printed green article. As shown in FIG. 2, the frequency at which the metal carbide precipitates occurred in the cobalt solid solution matrix phase was substantially less relative to FIG. 1. Additionally, the metal carbide precipitates were more dispersed and of finer grain size. Such differences in microstructure translate to differences in hardness and wear resistance, for example. In some embodiments, sintered powder cobalt-based alloy described herein has hardness of at least 60 HRC, whereas the sintered alloy in FIG. 2 exhibited hardness of about 40 HRC. Hardness values recited herein are determined according to ASTM E-18-02 Standard Test Method for Rockwell Hardness of Metallic Materials. In some embodiments, the sintered powder cobalt-based alloy has hardness selected from Table I.

TABLE I
Sintered Alloy Coating Hardness (HRC)
60-70
60-65
61-64

The metal carbide precipitates of sintered powder cobalt-based alloys described herein comprise chromium carbide precipitates and molybdenum carbide precipitates. In some embodiments, the chromium carbide precipitates are present in an amount of 35-50 weight percent of the sintered cobalt-based alloy. The chromium carbide precipitates can exhibit a crystalline structure selected from M₂₃C₆, M₇C₃ or mixtures thereof. In some embodiments, greater than 90 percent of the chromium carbide precipitates have an M₂₃C₆ crystal structure. Additionally, the molybdenum carbide precipitates can be present in an amount of 20 to 30 weight percent of the sintered cobalt-based alloy. In some embodiments, molybdenum carbide precipitates exhibit an M₆C crystalline structure.

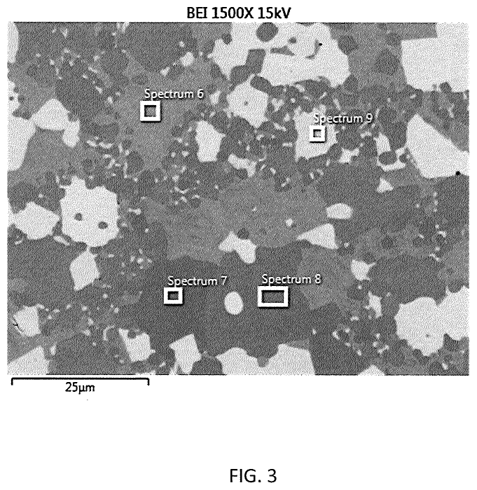

Chromium carbide precipitates and molybdenum carbide precipitates can comprise various solid solution compositions. Solid solutions formed in the chromium carbide and/or molybdenum carbide precipitates can be dependent on several considerations including, but not limited to, composition of the cobalt-based alloy and sintering conditions of the alloy. FIG. 3 is a cross-section SEM image of a sintered cobalt-based alloy described herein according to some embodiments. Energy dispersive spectra (EDS) were taken in several regions of the SEM to determine compositional parameters of the regions. The compositions parameters of each EDS spectrum are provided in Table II.

TABLE I
EDS Spectra Compositional Parameters

| | Spectrum 6 | Spectrum 7 | Spectrum 8 | Spectrum 9 |
|---|---|---|---|---|
| | (Co-matrix | (CrxCy | (CrxCy | (MoxCy |
| Element | alloy) | precipitate) | precipitate) | precipitate) |
| C | 4.28 | 8.37 | 8.40 | 8.82 |
| Si | 0.54 | — | — | 2.23 |
| Cr | 18.12 | 54.55 | 53.30 | 15.58 |
| Mn | 1.13 | 0.61 | 0.65 | — |
| Fe | 1.74 | 0.82 | 0.86 | 0.49 |
| Co | 64.38 | 22.12 | 22.60 | 27.95 |
| Ni | 3.51 | 0.53 | 0.82 | 1.48 |
| Mo | 6.30 | 12.99 | 12.99 | 43.45 |
| W | — | — | 0.37 | — |
| Total | 100.00 | 100.00 | 100.00 | 100.00 |

Chromium carbide and/or molybdenum carbide precipitates of articles described herein can be located at grain boundaries of the sintered cobalt-based alloy, as well as within the grains. Intergranular precipitation of the metal carbides can strengthen the cobalt solid solution matrix phase by providing impediments to movements of dislocations, thereby inhibiting crystallographic slip. Moreover, the cobalt solid solution matrix phase can comprise a crystalline structure including face-centered cubic (fcc) and hexagonal close packed (hcp) phases. In some embodiments, a ratio of fcc to hcp of the cobalt solid solution matrix phase ranges from 1.5 to 2.5.

Sintered cobalt-based alloy articles described herein, in some embodiments, are at least 98 percent theoretical density. Sintered cobalt-based alloy articles, for example, can be at least 99 percent theoretical density. In some embodiments, sintered cobalt-based alloys have less than 2 vol. % porosity or less than 1 vol. % porosity.

As described further below, sintered articles of the present application can be formed via one or more additive manufacturing techniques employing powder cobalt-based alloy. The powder cobalt-based alloy can have any compositional parameters consistent with achieving the microstructural characteristics described above. In some embodiments, the powder cobalt-based alloy has a composition selected from Table III.

TABLE III
Composition of Co-based Powder Alloy

| Element | Amount (wt. %) |
|---|---|
| Chromium | 15-35 |
| Tungsten | 0-10 |
| Molybdenum | 10-20 |
| Nickel | 0-5 |
| Iron | 0-5 |
| Manganese | 0-3 |
| Silicon | 0-5 |
| Vanadium | 0-5 |
| Carbon | 1.5-4 |
| Boron | 0-5 |
| Cobalt | Balance |

The powder cobalt-based alloy, for example, can comprise 29-33 wt. % chromium, 15-20 wt. % molybdenum, 0-0.1 wt. % tungsten, 1-3 wt. % nickel, 0.1-1 wt. % manganese, 0.5-3 wt. % —iron, 2-4 wt. % carbon, 0-2 wt. % silicon, 0.1-1 wt. % boron and the balance cobalt. In some embodiments, the cobalt-based powder alloy comprises one or more melting point reduction additives in an amount sufficient to permit liquid phase sintering of the alloy powder in a temperature range of 1140° C. to 1210° C. Melting point reduction additive can be one or more elemental components of the powder alloy. In some embodiments, elemental melting point reduction additives include silicon and/or boron. The cobalt-based alloy, for example, may contain silicon and/or boron in individual amounts of 0.1-2 wt. %.

Sintered cobalt-based alloy articles described herein can exhibit complex shapes and/or architectures. In some embodiments, the sintered cobalt-based alloy articles are flow control components, pumps, bearings, valves, valve components, centrifuge components, disk stacks, heat exchangers and/or fluid handling components. Such components can find application in various industries including, but not limited to, the oil and gas industries. In some embodiments, the sintered cobalt-based alloy articles comprises one or more internal channels or conduits for passing fluid through the article. The internal channels or conduits can have any desired size and cross-sectional geometry. In some embodiments, internal channels exhibit a circular or elliptical cross-section. Alternatively, the internal channels may have a polygonal or curve-linear cross-sectional geometry. Moreover, the internal channels or conduits can take any path through the sintered cobalt-based alloy articles. Internal channel pathways can be linear, curved, spiral, serpentine or any combination thereof.

### II. Methods of Forming Sintered Articles

In another aspect, methods of forming sintered articles are provided. A method comprises providing powder cobalt-based alloy and forming the powder cobalt-based alloy into a green article by one or more additive manufacturing techniques. The green article is sintered to provide the sintered article comprising sintered powder cobalt-based alloy having metal carbide precipitates dispersed in a cobalt solid solution matrix phase, wherein the metal carbide precipitates are present in an amount of at least 50 weight percent of the sintered powder cobalt-based alloy. Sintered articles produced according to methods described herein can have any composition and microstructural properties described in Section I above. The sintered articles, for example, can comprise metal carbide precipitates having composition, sizes, and occurrence frequencies described in Section I.

As set forth above, FIGS. 1 and 3 are cross-sectional images of sintered cobalt-based alloy articles fabricated according to methods described herein employing binder jetting additive manufacturing techniques. The articles of FIGS. 1 and 3, for example, were formed by binder jetting powder cobalt-based alloy having composition selected from Table III into a green article. The green article was cured in an oven at 190-210° C. for up to 12 hours followed by debindering at 690-710° C. for up to 90 minutes. The green article was subsequently solid state sintered at 950-1000° C. for 55-70 minutes, followed by liquid phase sintering in an ultrahigh vacuum furnace at 1175-1190° C. for 55-65 minutes. The foregoing sintering times and temperatures may be adjusted according to specific cobalt alloy composition. Binder jetting equipment from ExOne of Huntington, Pa. was employed to print the green article.

The green article is produced from a powder cobalt-based alloy via one or more additive manufacturing techniques. The powder cobalt-based alloy can have a composition selected from Table III, in some embodiments. Moreover, the powder cobalt-based alloy can have an average particle size of 10 μm to 100 μm, in some embodiments. The powder cobalt-based alloy, for example can have an average particle size of 15 μm to 80 μm or 20 μm to 30 μm. In some embodiments, the powder cobalt-based alloy has a D90 less than 45 μm. The powder cobalt-based alloy may also be a mixture of spherical, spheroidal, and rod-like particles.

Particle size of the cobalt-based alloy can be selected according to several considerations including, but not limited to, the additive manufacturing technique employed to fabricate the sintered article, powder packing characteristics, powder flow characteristics, and/or green article density. In some embodiments, green articles of methods described herein are greater than 50 percent theoretical density, where theoretical density is the density of the fully sintered cobalt-based alloy article. For example, a green article can be 51-55 percent theoretical density. Green articles having greater than 50 percent theoretical density can be produced via binder jetting, in some embodiments. Powder cobalt-based alloy, for example, can be selected to have a particle size distribution and morphology for producing green articles by binder jetting having densities greater than 50 percent theoretical density. Alternatively, powder cobalt-based alloy can be lightly sintered in a selective laser sintering process to produce green articles having densities greater than 50 percent theoretical density.

When binder jet additive manufacturing techniques are employed to produce the green article, any organic binder consistent with the objectives of the present invention can be used. In some embodiments, organic binder comprises one or more polymeric materials, such as polyvinylpyrrolidone (PVP), polyethylene glycol (PEG) or mixtures thereof. Organic binder, in some embodiments, is curable which can enhance strength of the green article. Polymer binder used in printing can be aqueous binder or solvent binder. Additionally, the green articles can exhibit binder saturation of at least 80%, in some embodiments. Binder saturation, for example, can be set to 100% or greater than 100%, in some embodiments. Green articles comprising powder cobalt-based alloy can be produced with binder jetting equipment from ExOne of Huntingdon, Pa.

Green articles can exhibit a single piece or monolithic architecture, in some embodiments. Green articles, in other embodiments, can comprise at least two individual segments defining an interface between the two individual segments. Any number of individual or independent segments is possible. Number of individual segments can be determined according to various considerations including size and/or geometry of the green article as well as the inclusion of any internal channels or conduits for passing fluids. In some embodiments, the green article is provided in multiple segments to permit removal of loose powder that accumulates during the additive manufacturing build process. The individual green segments are assembled into the complete green article and sintered to provide the sintered cobalt-based alloy article. In some embodiments, the green segments can be aligned by one or more alignment structures, such as pins, clamps and/or braces. The green segments may also comprise male/female mating parts for ensuring proper alignment when forming the complete green article for sintering. As the green segments can be produced independent of one another, the segments can have the same or differing composition and/or properties. In some embodiments, composition of the powder cobalt-based alloy can vary between individual segments. Moreover, green densities between the individual segments can vary, in some embodiments.

Green articles can be dry and liquid phase sintered at temperatures and for times to produce sintered articles having desired density. In some embodiments, green articles are sintered at temperatures of 1140° C. to 1210° C. and for times of 0.25 to 3 hours. Sintered cobalt-based alloy articles can be at least 98 percent theoretical density, in some embodiments. Sintered cobalt-based alloy articles can be at least 99 percent theoretical density, in some embodiments. Additionally, the sintered cobalt-based alloy articles can be free of cracks, including surface cracks. Sintering of the green articles can be conducted in vacuum or under an inert atmosphere. Compaction pressures, such as hot isostatic pressing, may be optional to produce sintered cobalt-based alloy articles having the high density values described hereinabove.

When the green article is formed of multiple green segments, the segments are arranged to contact one another and sintered. Interfaces between the segments can be eliminated by the sintering process, rendering an single piece sintered article. In some embodiments, one or more interfaces between green segments may be filled with bonding alloy. Bonding alloy may have the same or different composition than the powder cobalt-based alloy of the green segments. In some embodiments, bonding alloy is provided to the interface as loose powder alloy or as an alloy sheet. Alternatively, bonding alloy can be applied to one or more interface surfaces as a slurry. Suitable slurry compositions, in some embodiments, are disclosed in U.S. Pat. Nos. 7,262,240 and 6,649,682, which are incorporated herein by reference in their entireties.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. An article comprising:
sintered powder cobalt-based alloy having metal carbide precipitates dispersed in a cobalt solid solution matrix phase, wherein the metal carbide precipitates are present in an amount of at least 50 weight percent of the sintered powder cobalt-based alloy.

2. The article of claim 1, wherein the metal carbide precipitates are present in an amount of at least 60 weight percent.

3. The article of claim 1, wherein the metal carbide precipitates are present in an amount of 55 to 75 weight percent.

4. The article of claim 1, wherein the metal carbide precipitates comprise chromium carbide precipitates and molybdenum carbide precipitates.

5. The article of claim 4, wherein the chromium carbide precipitates are present in an amount of 35-50 weight percent of the sintered cobalt-based alloy.

6. The article of claim 4, wherein greater than 90 percent of the chromium carbide precipitates have an M₂₃C₆ crystal structure.

7. The article of claim 4, wherein the molybdenum carbide precipitates are present in an amount of 20 to 30 weight percent of the sintered cobalt-based alloy.

8. The article of claim 7, wherein the molybdenum carbide precipitates have an M₆C crystal structure.

9. The article of claim 1, wherein the metal carbide precipitates are interconnected throughout the cobalt solid solution matrix phase.

10. The article of claim 1, wherein the cobalt solid solution matrix phase comprises a crystalline structure including face centered cubic (fcc) and hexagonal close packed (hcp) phases.

11. The article of claim 10, wherein a ratio of fcc to hcp ranges from 1.5 to 2.5.

12. The article of claim 1, wherein the sintered powder cobalt-based alloy is at least 98 percent theoretical density.

13. The article of claim 1, wherein the sintered powder cobalt-based alloy has less than 2 vol. % porosity.

14. The article of claim 1, wherein the sintered powder cobalt-based alloy has hardness of at least 60 HRC.

15. A method of forming a sintered article comprising:
providing powder cobalt-based alloy;
forming the powder cobalt-based alloy into a green article by one or more additive manufacturing techniques; and
sintering the green article to provide the sintered article comprising sintered powder cobalt-based alloy having metal carbide precipitates dispersed in a cobalt solid solution matrix phase, wherein the metal carbide precipitates are present in an amount of at least 50 weight percent of the sintered powder cobalt-based alloy.

16. The method of claim 15, wherein the metal carbide precipitates are present in an amount of 55 to 75 weight percent.

17. The method of claim 15, wherein the metal carbide precipitates comprise chromium carbide precipitates and molybdenum carbide precipitates.

18. The method of claim 15, wherein the chromium carbide precipitates are present in an amount of 35-50 weight percent of the sintered cobalt-based alloy.

19. The method of claim 15, wherein the molybdenum carbide precipitates are present in an amount of 20 to 30 weight percent of the sintered cobalt-based alloy.

20. The method of claim 15, wherein the metal carbide precipitates are interconnected throughout the cobalt solid solution matrix phase.

21. The method of claim 15, wherein particles of the cobalt-based alloy have a D90 less than 45 μm.

22. The method of claim 15, wherein the green article is formed via binder jetting.
